(19) United States
(12) Patent Application Publication
(10) Pub. No.: US 2025/0272405 A1
(43) Pub. Date: Aug. 28, 2025

(54) OTA SECURITY UPDATE METHOD AND SYSTEM FOR INTELLIGENT CONNECTED VEHICLES

(71) Applicant: Changzhou Institute of Technology, Changzhou City (CN)

(72) Inventors: Jiping LI, Changzhou City (CN); Ying SHI, Changzhou City (CN); Guangqian XIE, Changzhou City (CN); Huijun HAN, Changzhou City (CN); Yuting WANG, Changzhou City (CN)

(21) Appl. No.: 18/905,127

(22) Filed: Oct. 2, 2024

(30) Foreign Application Priority Data
Feb. 26, 2024 (CN) 202410205707.X

(51) Int. Cl. G06F 21/57; H04L 9/32

(52) U.S. Cl. CPC G06F 21/572; H04L 9/3236; H04L 9/3247

(57) ABSTRACT

An OTA security update method and system for intelligent connected vehicles are provided. The method includes: the downloaded software update packet from a CDN to UC-master is decrypted, and verified for the first time through signature verification; for the secondary verification, decomposing a current software update packet into a plurality of sub-packets; calculating HASH values of the sub-packets in sequence; thereafter, constructing a Merkle tree according to these HASH values; calculating a root HASH value of the Merkle tree; after the sub-packets are transferred from a UC-master to ECU-UAs through a gateway or a domain controller, recalculating the HASH values of the sub-packets; reconstructing the Merkle tree according to these HASH values; recalculating the root HASH value of the Merkle tree; comparing the two HASH values; if they are equal, starting a normal update procedure; otherwise, terminating this OTA update by the UC-master immediately.

### CROSS-REFERENCE TO RELATED APPLICATION

This patent application claims the benefit and priority of Chinese Patent Application No. 202410205707X filed with the China National Intellectual Property Administration on Feb. 26, 2024, the disclosure of which is incorporated by reference herein in its entirety as part of the present application.

### TECHNICAL FIELD

The present disclosure relates to a vehicle Over-the-Air (OTA) update technology, in particular to OTA security update method and system for intelligent connected vehicles.

### BACKGROUND

In recent years, an intelligent connected vehicle has become a strategic direction of development of the global vehicle industry. The vehicle industry has gradually embarked on the road of reform of a Software Defined Vehicle (SDV). With the “electrification, intelligence, networking and sharing” of vehicles, the SDV has become a new industry consensus in recent years. With the rapid development of intelligent connected vehicles, the intelligent level of vehicle parts is constantly improving, more and more software is carried in vehicles, the complexity of vehicles is increasing, and the vehicle software is updated more and more frequently, and vehicle companies and users are facing more and more difficulties in software maintenance. Under this background, a remote update (Over-the-Air, OTA) achieves remote management of vehicle systems and applications through an air interface of mobile communications, and has gradually become the mainstream technology to achieve maintenance and management of the vehicle software. The OTA technology not only can bring more convenient ways to update the vehicle software, but also make consumers feel more intelligent and more convenient vehicle experience. Moreover, for the majority of vehicle companies, the OTA technology can help vehicle companies achieve vehicle function update, performance optimization and defect repair, which can greatly reduce the recall cost of vehicles, realize unified management of vehicle software and vehicle data, and improve the efficiency and quality of after-sales service.

However, under the background of the gradual electrification and networking of vehicles, the OTA will expose the entrance of the vehicle software update to the network, and will increase the attack surface of vehicle network security, which leads to three major security threats for vehicles. A first security threat is identity impersonation attack, that is, the attacker pretends to be a sender or receiver in the OTA communication. A second security threat is eavesdropping attack, that is, the attacker steals the data packet in the OTA transmission process, thus acquiring the sensitive information in the update packet. A third security threat is data tampering, that is, the attacker tampers with the OTA update packet and attacks vehicles in a manner of implanting malicious software and viruses.

At present, a domestic Original Equipment Manufacturer (OEM) generally integrates the OTA update function on mass-production vehicles, and ensures the security of the OTA update by implementing security strategies such as an update verification method. At present, there are two common OTA update verification methods. A first method is to calculate the HASH value of the update packet based on the HASH algorithm, such as MD5, SHA-1, etc. After the update packet is received by a vehicle terminal, a vehicle-side update controller (UC-master) uses the same HASH algorithm to calculate the HASH value of the received update packet. By comparing the HASH values of the update packet before and after transmission, the integrity of the received update packet is verified, thus verifying the OTA update. However, the attacker can bypass the verification method by tampering with the HASH value and the verification logic. A second method is signature verification based on a signature algorithm. The verification method uses a Public Key Infrastructure (PKI) system to generate a public-private key pair for the OTA cloud server, and the OTA cloud server uses a private key to perform the encryption operation on the update packet data or other variables related to the data content, thus realizing the signature of the update packet. The vehicle-side UC-master uses a public key of the OTA cloud server to verify the received “digital signature”, so as to verify the integrity of the update data packet and ensure the security of the OTA update. Although “the signature verification method” can ensure the legitimacy and the integrity of the update data packet, in the actual update process, an update data packet is usually packed into a plurality of update packets according to different types and configurations of electronic control units (ECUs), and then the plurality of update packets are transmitted to the target ECUs through a gateway or a domain controller to update and refresh the target ECUs. Usually, the target ECUs will not perform secondary verification on the received update packet. As the attacking means of the attacker continue to upgrade now, the attacker can replace/tamper with the update packet of the target ECU after UC-master has finished verifying and unpacking the whole update packet, so as to achieve the purpose of malicious update. Although some schemes use a digital signature or a hash message authentication code (HMAC) for secondary verification, and then performs update, refresh and installing after the verification is successful, the secondary signature or the hash message authentication code (HMAC) needs an encryption and decryption operation, which requires high performance and security of the ECU and other parts, and is only suitable for an intelligent ECU, not suitable for an embedded ECU, and low in execution efficiency.

Among the above three update methods, the first two update methods have certain security threats. The verification based on the signature algorithm ensures the legality and the integrity of the whole update packet, but it is impossible to perform the secondary verification on the update packet of the target ECU in the update process, which leads to certain security hazards in the OTA at present and affects the security of the OTA update of the whole vehicle. A third update method uses a digital signature or a hash message authentication code (HMAC) for secondary signature verification. However, due to many sub-packets for signature verification and the influence of the performance and security of the ECU and other parts, the execution efficiency is low. Moreover, this method is only suitable for an intelligent ECU, but is not suitable for an embedded ECU. Therefore, how to realize the efficient verification, storage and flexible addition or modification of the current ECU update sub-packet is a key technical problem to be solved.

### SUMMARY

Aiming at the security threats existing in the verification of a vehicle-side software update packet based on a one-time signature algorithm in the prior art, and the problem that the secondary signature verification method based on the digital signature or the hash message authentication code (HMAC) cannot achieve the efficient update of the embedded ECU software, the present disclosure provides an Over-the-Air (OTA) security update method and a system for an intelligent connected vehicle, which solve the problem of secondary verification of an update sub-packet after unpacking the current OTA update software packet, and prevents the attacker from replacing or tampering with the update software sub-packet of the target ECU after the vehicle-side UC-master completes the verification and unpacking of the whole update packet and achieving the purpose of a malicious update.

The purpose of the present disclosure is achieved by the following technical scheme.

An OTA security update method for an intelligent connected vehicle is provided, which includes three stages of a system key initialization, a software update packet building, and a vehicle-side software packet downloading, secondary verification and updating. In the stage of vehicle-side software packet downloading, secondary verification and updating: after a vehicle-side UC-master downloads an encrypted software update packet from a Content Distribution Network (CDN), the downloaded encrypted software update packet is decrypted with its private key, and a first integrity verification of an OTA software update packet is completed through a digital signature algorithm. In a case that the first integrity verification of the OTA software update packet is passed, a current OTA software update packet is decomposed into a plurality of software update sub-packets, a HASH operation is performed on respective software update sub-packets to obtain HASH values of respective software update sub-packet in sequence. A Merkle tree is constructed according to these HASH values, a root HASH value of the Merkle tree is calculated. After the software update sub-packets are transferred from a UC-master to an ECU-UA (ECU Update Agent) through a gateway or a domain controller, the HASH values of respective software update sub-packets are solved again, the Merkle tree is reconstructed again according to these HASH values, the root HASH value of the Merkle tree is solved again. A root HASH value of the Merkle tree after the UC-master receives the software update sub-packets is compared with a root HASH value of the Merkle tree after the ECU-UA receives the software update sub-packets to realize a second integrity verification of the software update packet. In a case that the two HASH values are equal to each other, it indicates that the software update sub-packets are not replaced or tampered with in a transmission process, an integrity of the update packet is protected, and a normal update program is capable of being started; otherwise, it indicates that the software update sub-packets are replaced or tampered with in the transmission process, and the UC-master immediately terminates this OTA update.

In the stage of system key initialization, an OTA cloud service platform and a vehicle-side OTA system are configured with key pairs (PK2, SK1) and (PK1, SK2), respectively, by interacting with a Public Key Infrastructure (PKI) service cloud platform, where PK1 and SK1 are a public key and a private key of the OTA cloud service platform, and PK2 and SK2 are a public key and a private key of the vehicle-side OTA system.

The stage of software update packet building is used to complete a preparation of the vehicle-side software update packet, and upload the software update packet to a CDN to form a download link URL, which includes: uploading, by a software update packet supplier, an software update packet Packet to an OTA cloud service platform, performing, by the OTA cloud service platform, a digital signature operation on the whole software update packet Packet by using a private key SK1 of the OTA cloud service platform, performing an encryption operation on the update packet Packet, an encrypted digest/and the root HASH value Hₗₙ of the Merkle tree constructed according to the HASH values of the software update sub-packets P1, P2, . . . , Pn by using a public key PK2 of the vehicle-side UC-master, and uploading the encrypted update packet Packet″ to the CDN to form the download link URL.

In the stage of vehicle-side software packet downloading, secondary verification and updating, the vehicle-side UC-master downloads an encrypted software update packet Packet″ decrypts the Packet″ with its own private key SK2, verifies a digital signature with a public key PK1 of an OTA cloud service platform, and transmits a decrypted root HASH value Hₗₙ of the Merkle tree to a comparison module through a secure channel. In a case that a signature verification is passed, respective software update sub-packets P1, P2, . . . , Pn are transmitted to a target ECU-UA through a gateway or a domain controller, and a Merkle tree is constructed according to the HASH values of the software update sub-packets received by respective ECU-UAs, a root HASH value H*ₗₙ, of the Merkle tree is calculated and transmitted to the comparison module. In the case that H*ₗₙ=Hₗₙ, the second integrity verification of the software update packet is completed, and each ECU is updated, refreshed and installed.

The specific implementation steps of the stage of system key initialization include Steps S1 to S3.

In Step S1, the OTA system is activated, and a public-private key pair (PK1, SK1) is applied for, by the OTA cloud service platform, from the PKI service cloud platform.

In Step S2, the public-private key pair (PK1, SK1) is generated at the PKI service cloud platform, and returned to the OTA cloud service platform. The private key SK1 is saved on the OTA cloud service platform, and the public key PK1 is sent to the UC-master of the vehicle-side OTA system.

In Step S3, a public-private key pair (PK2, SK2) is applied for, by the vehicle-side UC-master, from the PKI service cloud platform, the public-private key pair (PK2, SK2) is generated by the PKI service cloud platform and sent to the vehicle-side UC-master. The private key SK2 is saved at the vehicle-side UC-master and the public key PK2 is sent to the OTA cloud service platform.

The specific implementation steps of the stage of software update packet building include Steps S4 to S7.

In Step S4, the software update packet Packet=P(P1, P2, . . . , Pn) is uploaded, by the software update packet supplier, to the OTA cloud service platform.

In Step S5, the HASH operation is performed, by the OTA cloud service platform, on software update sub-packets P1, P2, . . . , Pn to obtain HASH values H1, H2, . . . , Hn, the Merkle tree is constructed, the root HASH value Hₗₙ of the Merkle tree is calculated, and the HASH value is transmitted to an encryption algorithm module.

In Step S6, the HASH operation is performed, by the OTA cloud service platform, on the software update packet Packet to obtain a message digest D=H(Packet), and a message digest D is encrypted with a private key SK1 of the OTA cloud service platform, to form an encrypted digest D′=EN_{SK1}(D), where EN_{SK1}(#) indicates that the encryption operation is performed on # with the private key SK1, the encrypted digest D′ is attached behind the Packet to form a data packet Packet′=(Packet, D′), and the encryption operation is performed on the data packet Packet′ and Hₗₙ with the public key PK₂ of the vehicle-side UC-master to form an encrypted data packet Packet″=EN_{PK}_{₂}(Packet′, Hₗₙ) of the update software, and the encrypted update data packet Packet″ is distributed to the CDN.

In Step S7, a download link URL forming message is returned by the CDN, and an update command to the CDN is issued, by an OTA administrator, through a Web console, after receiving the download link URL forming message.

The specific implementation steps of the stage of vehicle-side software packet downloading, secondary verification and updating include Steps S8 to S12.

In Step S8, the encrypted data packet Packet″ of the update software is downloaded, by the vehicle-side UC-master, according to the download link URL.

In Step S9, a decryption operation (Packet′, Hₗₙ)=DE_{SK}_{₂}(Packet″) is performed, by the vehicle-side UC-master, on the downloaded encrypted data packet Packet″ of the update software with a private key SK2 of the vehicle-side UC master, where DE_{SK}_{₂}(#) indicates that the decryption is performed on # with the private key SK2 to obtain an original software update packet Packet=P(P1, P2, . . . , Pn), an encrypted digest D′ and the root HASH value Hₗₙ of the Merkle tree.

In Step S10, the signature verification is performed, by the vehicle-side UC-master, on the decrypted software update packet Packet and the encrypted digest D′. Firstly, the UC-master computes the digest of the original software update packet D according to D=DE_{PK}_{₁}(D′) by using the public key PK1 of the OTA cloud service platform. Secondly, the HASH operation is performed on the decrypted original software update packet Packet to obtain a message digest D* according to D*=H(Packet). Finally, the UC-master checks D*?=D. In a case that D* and D are equal to each other, the first integrity verification of the software update packet is passed. In a case that D* and D are not equal to each other, the vehicle-side UC-master destroys the received Packet″ and terminates the update process.

In Step S11, the second integrity verification of the software update sub-packets received by the ECU-UA is performed, which includes: the UC-master performs an unpacking operation on the decrypted original software update packet Packet to obtain the software update sub-packets P1, P2, . . . , Pn, and transmits the software update sub-packets to the ECU-UAs corresponding to respective ECUs through a communication gateway and a communication network between the ECUs such as a CAN bus, LAN interconnection network (LIN), vehicle Ethernet, WIFI or Bluetooth, the UC-master performs the HASH operation on the software update sub-packets P1, P2, . . . , Pn received by respective ECU-UAs to obtain HASH values H*₁, H*₂, . . . , H*ₙ corresponding to the software update sub-packets P1, P2, . . . , Pn, constructs the Merkle tree according to a method shown in FIG. 2A-FIG. 2B, calculates the root HASH value H*ₗₙ of the Merkle tree, and checks H*ₗₙ?=Hₗₙ. In a case that H*ₗₙ and Hₗₙ are not equal to each other, it indicates that at least one of the software update sub-packets P1, P2, . . . , Pn is tampered with and its integrity is destroyed in the process of being transmitted to the target ECU-UA through the gateway or the domain controller, and thus the ECU-UA destroys the received software update sub-packets P1, P2, . . . , Pn, and terminates update of respective ECUs.

In Step S12, in a case that H*ₗₙ and Hₗₙ are equal to each other, the second integrity verification is passed, and the UC-master updates, refreshes and installs respective ECUs to complete update operations.

An Over-the-Air (OTA) security update system for an intelligent connected vehicle is further provided, which includes an OTA cloud service platform, a Public Key Infrastructure (PKI) service cloud platform and a vehicle-side OTA system, where the OTA cloud service platform includes an OTA service platform, a CDN file service, an OME-IT system and a Web console, which are used to realize OEM cloud docking, vehicle model/vehicle/ECU version information management, software update management, update strategy creation, ECU associated update configuration, update mode configuration, release, etc. The PKI service cloud platform is used to generate encrypted and decrypted public-private key pairs, and the private key is used to generate a signature of an update packet, and the public key is used to verify the signature. The vehicle-side OTA system includes an OTA update master, a signature verification module, a Merkle tree construction and root HASH value calculation module, a Merkle tree root HASH value comparison module, an updated ECU, a communication gateway between ECUs and a communication network between ECUs inside a vehicle.

Compared with the prior art, the present disclosure has the following advantages. 1) The software update packet downloaded by the vehicle-side UC-master from the CDN is transmitted in an encrypted way, so as to guarantee the confidentiality of sensitive information in the software update packet, prevent the adverse consequences resulted from the leakage of sensitive information, and effectively protect the interests of vehicle enterprises and software suppliers. 2) In the process of transmitting the software update sub-packets from the UC-master to the target ECUs through the gateway or the domain controller, its integrity is verified by comparing the root HASH values of the Merkle tree before and after transmission. Because of the adoption of simple HASH operation, it is suitable for the embedded ECUs with limited resources which is not suitable for the secondary signature algorithm. Compared with the secondary signature scheme, the method is not only high in efficiency and low in energy consumption, but also is simpler in the implementation mode, saving the time of vehicle software update. 3) The storage overhead can be greatly reduced. The secondary signature scheme creates a signature for each software update sub-packet independently. The Merkle tree can realize the second integrity verification of the downloaded software update packet only by storing a root HASH value of the Merkle tree and the signature of the whole packet, which has a very small storage overhead. 4) The method has a high local modification efficiency. When a software update sub-packet is modified or a new software update sub-packet corresponding to the ECU is added, unlike the secondary signature scheme that all software update sub-packets corresponding to the ECU need to be re-signed, only the HASH values of the affected relevant nodes need to be re-calculated, and the efficiency of local modification is higher.

### BRIEF DESCRIPTION OF THE DRAWINGS

FIG. 1 is a flow chart of the present disclosure.

FIG. 2A-FIG. 2B are diagrams showing a composition and working principle of a system according to the present disclosure.

FIG. 3 is a schematic diagram of constructing a Merkle tree and calculating a root HASH value of a Merkle tree with an even number of software update sub-packets (taking four update sub-packets as an example).

FIG. 4 is a schematic diagram of constructing a Merkle tree and calculating a root HASH value of a Merkle tree with an odd number of software update sub-packets (taking five update sub-packets as an example).

### DETAILED DESCRIPTION OF THE EMBODIMENTS

The present disclosure will be described in detail with reference to the attached drawings in the specification and specific embodiments hereinafter.

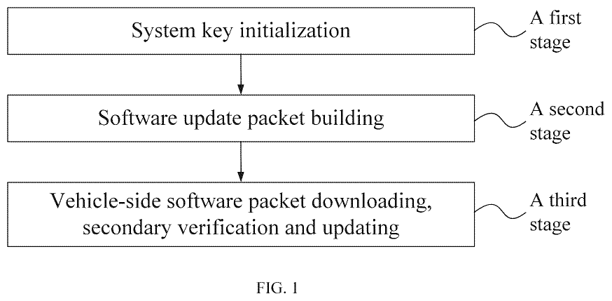

As shown in FIG. 1, an Over-the-Air (OTA) security update method for intelligent connected vehicles is provided, which includes three stages of system key initialization, a software update packet building, and a vehicle-side software packet downloading, secondary verification and updating. After a vehicle-side UC-master downloads an encrypted software update packet from a Content Distribution Network (CDN), the downloaded encrypted software update packet is decrypted with its private key, a first integrity verification of an OTA software update packet is implemented through a digital signature algorithm. In a case that the first integrity verification of the OTA software update packet is passed, a current OTA software update packet is decomposed into a plurality of software update sub-packets. A HASH operation is performed on respective software update sub-packets, to obtain HASH values of respective software update sub-packets in sequence. A Merkle tree is constructed according to these HASH values, and then the root HASH value of the Merkle tree is calculated. After the software update sub-packets are transferred from a UC-master to an ECU-UA through a gateway or a domain controller, the HASH values of respective software update sub-packets are solved again. The Merkle tree is reconstructed again according to these HASH values, and the root HASH value of the Merkle tree is solved. A root HASH value of the Merkle tree after the UC-master receives the software update sub-packets is compared with a root HASH value of the Merkle tree after the ECU-UA receives the software update sub-packets to realize the second integrity verification. In a case that the two root HASH values are equal to each other, it indicates that the software update sub-packets are not replaced or tampered with in a transmission process, an integrity of the update packet is protected, and a normal update program is capable of being started; otherwise, it indicates that the software update sub-packets are replaced or tampered with in the transmission process, and the UC-master immediately terminates this OTA update.

In the stage of system key initialization, an OTA cloud service platform and a vehicle-side OTA system configure a key pair of the OTA cloud service platform as (PK2, SK1) and a key pair of the vehicle-side OTA system as (PK1, SK2) by interacting with a Public Key Infrastructure (PKI) service cloud platform, where PK1 and SK1 are a public key and a private key of the OTA cloud service platform, respectively, and PK2 and SK2 are a public key and a private key of the vehicle-side OTA system, respectively.

In the stage of software update packet building, the vehicle-side software update packet is prepared, and uploaded to a CDN to form a download link URL. Specifically, a software update packet supplier uploads an intelligent connected vehicle software update packet Packet to an OTA cloud service platform, the OTA cloud service platform perform a digital signature operation on the whole software update packet Packet by using a private key SK1 of the OTA cloud service platform and perform an encryption operation on the update packet Packet, an encrypted digest D′ and the root HASH value Hₗₙ of the Merkle tree constructed according to the HASH values of the software update sub-packets P1, P2, . . . , Pn by using a public key PK2 of the vehicle-side UC-master, and uploads the encrypted update packet Packet″ to the CDN to form the download link URL.

In the stage of vehicle-side software packet downloading, secondary verification and updating, the vehicle-side UC-master downloads an encrypted software update packet Packet″, decrypts the Packet″ with its own private key SK2, verifies a signature with a public key PK1 of an OTA cloud service platform, and transmits a decrypted root HASH value Hₗₙ of the Merkle tree to a comparison module through a secure channel. In a case that a signature verification is passed, respective software update sub-packets P1, P2, . . . , Pn are transmitted to a target ECU-UA through a gateway or a domain controller, a Merkle tree is constructed according to the HASH values of the update sub-packets received by respective ECU-UAs, and a root HASH value H*ₗₙ of the Merkle tree is calculated and transmitted to the comparison module. In a case that H*ₗₙ=Hₗₙ, the second integrity verification of the software update packets is completed, and each ECU is updated, refreshed and installed.

Compared with the secondary signature verification scheme, the Merkle tree can realize the secondary integrity verification of the software update sub-packets efficiently, which has four obvious advantages. 1) The software update packet downloaded by the vehicle-side UC-master from the CDN is transmitted in an encrypted way, so as to guarantee the confidentiality of sensitive information in the software update packet, prevent the adverse consequences resulted from the leakage of sensitive information, and effectively protect the interests of vehicle enterprises and software suppliers. 2) In the process of transmitting the software update sub-packets from the UC-master to the target ECU-UA through the gateway or the domain controller, its integrity is verified by comparing the root HASH value of the Merkle tree before and after transmission. Because of the adoption of simple HASH operation, it is suitable for the embedded ECU with limited resources which is not suitable for the secondary signature algorithm. Compared with the secondary signature scheme, the proposed method is not only high in efficiency and low in energy consumption, but also is simpler in the implementation mode, saving the time of vehicle software update. 3) The storage overhead can be greatly reduced. The secondary signature scheme creates a signature for each software update sub-packet independently, and the second integrity verification of the downloaded software update packet can be realized by Merkle tree only through storing a root HASH value of the Merkle tree and the signature of the whole packet, which has a very small storage overhead. 4) The proposed method has a high local modification efficiency. When a software update sub-packet is modified or a new software update sub-packet corresponding to the ECU is added, unlike the secondary signature scheme in which all software update sub-packets corresponding to the ECU need to be re-signed, only the HASH values of the affected relevant nodes need to be re-calculated, and the efficiency of local modification is higher.

The specific implementation steps of the stage of system key initialization include Steps S1 to S3.

In Step S1, the OTA system is activated, and the OTA cloud service platform applies for a public-private key pair (PK1, SK1) from the PKI service cloud platform.

In Step S2, the public-private key pair (PK1, SK1) is generated at the PKI service cloud platform, the public-private key pair (PK1, SK1) is returned to the OTA cloud service platform, the private key SK1 is saved at the OTA cloud service platform, and the public key PK1 is sent to the UC-master of the vehicle-side OTA system.

In Step S3, the vehicle-side UC-master applies for a public-private key pair (PK2, SK2) from the PKI service cloud platform, the PKI service cloud platform generates the public-private key pair (PK2, SK2) and sends the public-private key pair (PK2, SK2) to the vehicle-side UC-master, and the private key SK2 is saved at the vehicle-side UC-master and the public key PK2 is sent to the OTA cloud service platform.

The specific implementation steps of software update packet building stage include Steps S4 to S7.

In Step S4, the software update packet supplier uploads the intelligent connected vehicle software update packet Packet=P(P1, P2, . . . , Pn) to the OTA cloud service platform.

In Step S5, the OTA cloud service platform performs HASH operation on each of software update sub-packets P1, P2, . . . , Pn to obtain HASH values H1, H2, . . . , Hn, and constructs the Merkle tree, calculates a root HASH value Hₗₙ of the Merkle tree, and transmits the root HASH value Hₗₙ to an encryption algorithm module.

In Step S6, the OTA cloud service platform performs HASH operation on the software update packet Packet to obtain a message digest D=H(Packet), and encrypts the message digest D with a private key SK1 of the OTA cloud service platform, to form an encrypted digest D′=EN_{SK1}(D), where EN_{SK1}(#) indicates that the encryption operation is performed on # with the private key SK1. Subsequently, the encrypted digest D′ is attached behind the Packet to form a data packet Packet′=(Packet, D′), and the encryption operation is performed on the data packet Packet′ and Hₗₙ with the public key PK₂ of the vehicle-side UC-master to form an encrypted software update packet Packet″=EN_{PK}_{₂}(Packet′, Hₗₙ) . Next, the encrypted software update packet Packet″ is distributed to the CDN.

In Step S7, the CDN returns a download link URL forming message, and an OTA administrator issues an update command to the CDN through a Web console after receiving the download link URL forming message.

The specific implementation steps of the stage of vehicle-side software packet downloading, secondary verification and updating include Steps S8 to S12.

In Step S8, the vehicle-side UC-master downloads the encrypted data packet Packet ″ of the update software according to the download link URL.

In Step S9, the vehicle-side UC-master performs a decryption operation (Packet′, Hₗₙ)=DE_{SK}_{₂}(Packet″) on the downloaded encrypted data packet Packet″ of the update software with a private key SK2 of the vehicle-side UC-master, where DE_{SK}_{₂}(#) indicates that the decryption operation is performed on # with the private key SK2 to obtain an original software update packet Packet=P(P1, P2, . . . , Pn), the encrypted digest D′, and the root HASH value Hₗₙ of the Merkle tree.

In Step S10, the signature verification is performed by vehicle-side UC master, on the decrypted software update packet Packet and the encrypted digest D′. Firstly, the vehicle-side UC-master computes the digest of the original software update packet D according to D=DE_{PK}_{₁}(D′) by using the public key PK1 of the OTA cloud service platform. Secondly, the HASH operation is performed on the decrypted original software update packet Packet to obtain a message digest D* according to D*=H(Packet). Finally, the UC-master checks D*?=D. In a case that D* and D are equal to each other, the first integrity verification of the software update packet is passed. In a case that D* and D are not equal to each other, the vehicle-side UC-master destroys the received Packet″ and terminates the update process.

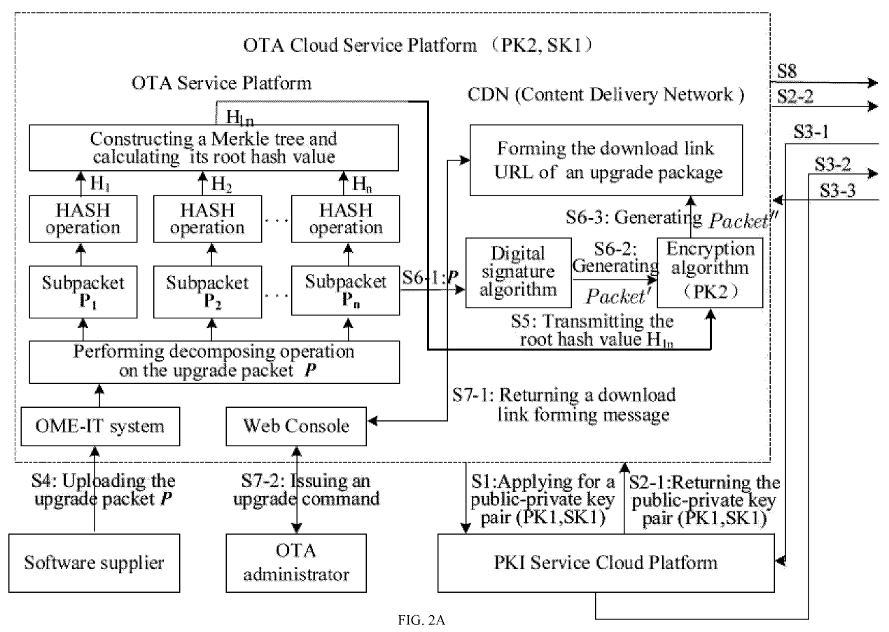

In Step S11, the second integrity verification of the software update sub-packet received by the ECU-UA is performed, which includes: the UC-master performs an unpacking operation on the decrypted original software update packet Packet to obtain the software update sub-packets P1, P2, . . . , Pn, and transmits the software update sub-packets to ECU-UAs corresponding to respective ECUs through a communication gateway and a communication network between the ECUs such as a CAN bus, LAN interconnection network (LIN), vehicle Ethernet, WIFI or Bluetooth. Subsequently, the UC-master performs the HASH operation on the software update sub-packets P1, P2, . . . , Pn received by respective ECU-UAs to obtain HASH values H*₁, H*₂, . . . , H*ₙ corresponding to the software update sub-packets P1, P2, . . . , Pn, and constructs the Merkle tree according to a method shown in FIG. 2A-FIG. 2B, calculates the root HASH value H*ₗₙ of the Merkle tree, and checks H*ₗₙ?=Hₗₙ. In a case that H*ₗₙ and Hₗₙ are not equal to each other, it indicates that at least one of the software update sub-packets P1, P2, . . . , Pn is tampered with and its integrity is destroyed in the process of being transmitted to the target ECU-UA through the gateway or the domain controller, and thus the ECU-UA destroys the received software update sub-packets P1, P2, . . . , Pn, and terminates updates of each ECU.

In Step S12, in a case that H*ₗₙ and Hₗₙ are equal to each other, the second integrity verification is passed, and the UC-master updates, refreshes and installs respective ECUs to complete the update operation.

As shown in FIG. 2A-FIG. 2B, an Over-the-Air (OTA) security update system for an intelligent connected vehicle is provided, which includes an OTA cloud service platform, a Public Key Infrastructure (PKI) service cloud platform and a vehicle-side OTA system. The OTA cloud service platform includes an OTA service platform, a CDN file service, an OME-IT system and a Web console, which are used to realize OEM cloud docking, vehicle model/vehicle/ECU version information management, software update management, update strategy creation, ECU associated update configuration, update mode configuration, release, etc. The PKI service cloud platform is used to generate encrypted and decrypted public-private key pairs, and the private key is used to generate a signature of an update packet, and the public key is used to verify the signature. The vehicle-side OTA system includes an OTA update master, a signature verification module, a Merkle tree construction and root HASH value calculation module, a Merkle tree root HASH value comparison module, an updated ECU, a communication gateway between ECUs and a communication network between ECUs inside the vehicle.

As shown in FIG. 2A-FIG. 2B, after receiving the software update packet from the CDN, the vehicle-side UC-master performs a signature verification to verify the legitimacy and integrity of the received software update packet. If the signature verification fails, it indicates that the software update packet is tampered with or forged in the process of being transmitted to the vehicle-side UC-master, and the unpacking and updating work are terminated immediately. If the signature verification is passed, the vehicle-side UC-master starts to unpack the update packet Packet into P1, P2, . . . , Pn. After the software update packets are transmitted to the ECU-UAs, the HASH values of respective software update sub-packets are calculated, the Merkle tree is constructed according to these HASH values, and the root HASH value of the Merkle tree is calculated.

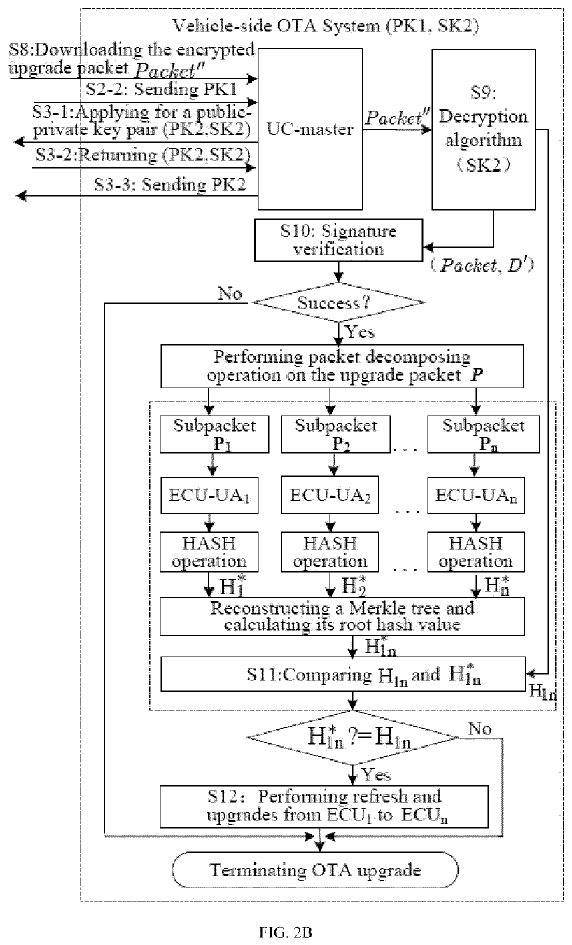

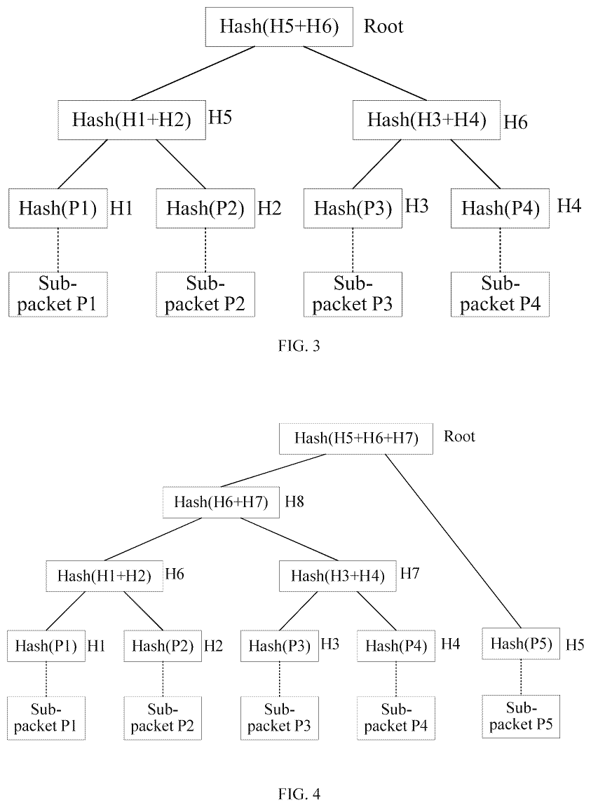

As can be seen from FIGS. 3 and 4, as long as any one of the software update sub-packets P1, P2, . . . , Pn is tampered with or forged, the HASH values of a parent node, a grandfather node . . . at the upper level will change, which will eventually change the root HASH value of the Merkle tree. The vehicle-side UC-master transmits the respective unpacked software update sub-packets P1, P2, . . . , Pn to the ECU-UAs (ECU Update Agents) corresponding to respective ECUs through a communication gateway and a communication network between the ECUs such as a CAN bus, LAN interconnection network (LIN), vehicle Ethernet, or other technologies (WIFI or Bluetooth). Subsequently, the UC-master calculates the HASH values of the software update sub-packets that arrive at the ECU-UAs in the same order, and constructs the Merkle tree and calculates the root HASH value of the Merkle tree in the same way as before, so as to prepare for the integrity verification of the ECU software update sub-packets.

What is claimed is:

1. An Over-the-Air (OTA) security update method for an intelligent connected vehicle, comprising three stages of a system key initialization, a software update packet building, and a vehicle-side software packet downloading, secondary verification and updating, wherein after a vehicle-side UC-master downloads an encrypted software update packet from a Content Distribution Network (CDN), the received encrypted software update packet is decrypted with its private key, a first integrity verification of an OTA software update packet is performed through a digital signature algorithm, in a case that the integrity verification of the OTA software update packet is passed, a current OTA software update packet is decomposed into a plurality of software update sub-packets, a HASH operation is performed on respective software update sub-packets, to obtain HASH values of respective software update sub-packets in sequence, a Merkle tree is constructed according to these HASH values, a root HASH value of the Merkle tree is calculated, after the software update sub-packets are transferred from a UC-master to an ECU-UA through a gateway or a domain controller, the HASH values of respective software update sub-packets are solved again, the Merkle tree is reconstructed again according to these HASH values, the root HASH value of the Merkle tree is solved, a root HASH value of the Merkle tree after the UC-master receives the software update sub-packets is compared with a root HASH value of the Merkle tree after the ECU-UA receives the software update sub-packets to realize a second integrity verification, in a case that the two HASH values are equal to each other, it indicates that the software update sub-packets are not replaced or tampered with in a transmission process, an integrity of a software update packet is protected, and a normal update program is capable of being started; otherwise, it indicates that the software update sub-packets are replaced or tampered with in the transmission process, and the UC-master immediately terminates this OTA update.

2. The method according to claim 1, wherein in the stage of system key initialization, an OTA cloud service platform is configured with a key pair (PK2, SK1), and a vehicle-side OTA system is configured with a key pair (PK1, SK2), by interacting with a Public Key Infrastructure (PKI) service cloud platform; wherein PK1 and SK1 are a public key and a private key of the OTA cloud service platform, respectively, and PK2 and SK2 are a public key and a private key of the vehicle-side OTA system, respectively.

3. The method according to claim 1, wherein the stage of software update packet building is used to complete a preparation of the vehicle-side software update packet, and upload the software update packet to a CDN to form a download link URL, which comprises uploading, by a software update packet supplier, a software update packet Packet to an OTA cloud service platform, performing, by the OTA cloud service platform, a signature operation on the whole software update packet Packet by using a private key SK1 of the OTA cloud service platform, performing an encryption operation on the update packet Packet, an encrypted digest D′ and the root HASH value Hₗₙ of the Merkle tree constructed according to the HASH values of the software update sub-packets P1, P2, . . . , Pn by using a public key PK2 of the vehicle-side UC-master, and uploading the encrypted update packet Packet″=EN_{PK}_{₁}(Packet′, Hₗₙ) to the CDN to form the download link URL.

4. The method according to claim 1, wherein in the stage of vehicle-side software packet downloading, secondary verification and updating, the vehicle-side UC-master downloads an encrypted software update packet Packet″, decrypts the Packet″ with its own private key SK2, verifies a signature with a public key PK1 of an OTA cloud service platform, and transmits a decrypted root HASH value Hₗₙ of the Merkle tree to a comparison module through a secure channel; in a case that a signature verification is passed, respective software update sub-packets P1, P2, . . . , Pn are transmitted to a target ECU-UA through a gateway or a domain controller, and a Merkle tree is constructed according to the HASH values of the software update sub-packets received by respective ECU-UAs, a root HASH value H*ₗₙ of the Merkle tree is calculated and transmitted to the comparison module; in a case that H*ₗₙ=Hₗₙ, the second integrity verification of the software update sub-packet is passed, and each ECU is updated, refreshed and installed.

5. The method according to claim 1, wherein implementation steps of the stage of system key initialization comprise:
S1, activating an OTA system, and applying, by the OTA cloud service platform, for a public-private key pair (PK1, SK1) from the PKI service cloud platform;
S2, at the PKI service cloud platform, generating, the public-private key pair (PK1, SK1), and returning the public-private key pair (PK1, SK1) to the OTA cloud service platform, and at the OTA cloud service platform, saving the private key SK1, and sending the public key PK1 to the UC-master of the vehicle-side OTA system; and
S3: applying, by the vehicle-side UC-master, for a public-private key pair (PK2, SK2) from the PKI service cloud platform, generating, by the PKI service cloud platform, the public-private key pair (PK2, SK2) and sending the public-private key pair (PK2, SK2) to the vehicle-side UC-master, and at the vehicle-side UC-master, saving the private key SK2 and sending the public key PK2 to the OTA cloud service platform.

6. The method according to claim 1, wherein implementation steps of the stage of software update packet building comprise:
S4: uploading, by the software update packet supplier, the software update packet Packet=P(P1, P2, . . . , Pn) to the OTA cloud service platform;
S5: performing, by the OTA cloud service platform, the HASH operation on software update sub-packets P1, P2, . . . , Pn to obtain HASH values H1, H2, . . . , Hn, and constructing the Merkle tree according to these HASH values, calculating a root HASH value Hₗₙ of the Merkle tree, and transmitting the HASH value Hₗₙ to an encryption algorithm module;
S6: performing by the OTA cloud service platform, the HASH operation on the software update packet Packet to obtain a message digest D=H(Packet), and encrypting a message digest D with a private key SK1 of the OTA cloud service platform, to form an encrypted digest D′=EN_{SK1}(D), wherein EN_{SK1}(#) indicates that the encryption operation is performed on # with the private key SK1, the encrypted digest D′ is attached behind the Packet to form a data packet Packet′(Packet, D′), and the encryption operation is performed on the data packet Packet′ and Hₗₙ with the public key PK₂ of the vehicle-side UC-master to form an encrypted data packet Packet″=EN_{PK}_{₂}(Packet′, Hₗₙ), and the encrypted update data packet Packet″ is distributed to the CDN; and
S7: returning, by the CDN, a download link URL forming message, and issuing, by an OTA administrator, an update command to the CDN through a Web console after receiving the download link URL forming message.

7. The method according to claim 1, wherein implementation step of the stage of vehicle-side software packet downloading, secondary verification and updating comprise:
S8: downloading, by the vehicle-side UC-master, the encrypted update data packet Packet″ of the update software according to the download link URL;
S9: performing, by the vehicle-side UC-master, a decryption operation (Packet′, Hₗₙ)=DE_{SK}_{₂}(Packet″) on the downloaded encrypted update data packet Packet″ of the update software with a private key SK2 of the vehicle-side UC-master, wherein DE_{SK}_{₂}(#) indicates that the decryption operation is performed on # with the private key SK2 to obtain an original software update packet Packet=P(P1, P2, . . . , Pn), an encrypted digest D′, and the root HASH value Hₗₙ of the Merkle tree;
S10: performing, by the vehicle-side UC-master, the signature verification on the decrypted software update packet Packet, which comprises: performing, by the vehicle-side UC-master, the decryption operation on the encrypted digest D′ by using the public key PK1 of the OTA cloud service platform to obtain a digest D=DE_{PK}_{₁}(D′) of the original software update packet, and performing the HASH operation on the decrypted original software update packet Packet to obtain a message digest D*=H(Packet) for verification, and checking D*?=D, wherein in a case that D* and D are equal to each other, the first integrity verification of the software update packet is passed; in a case that D* and D are not equal to each other, the vehicle-side UC-master destroys the received Packet″ and terminates the update process;
S11: performing an integrity verification on the software update sub-packets received by the ECU-UA to implement the second integrity verification, which comprises: performing by the UC-master, an unpacking operation on the decrypted original software update packet Packet to obtain the software update sub-packets P1, P2, . . . , Pn, and transmitting the software update sub-packets to ECU-UAs corresponding to respective ECUs through a communication gateway and a communication network between the ECUs such as a CAN bus, LAN interconnection network (LIN), vehicle Ethernet, WIFI or Bluetooth, and performing, by the UC-master, the HASH operation on the software update sub-packets P1, P2, . . . , Pn received by respective ECU-UAs to obtain HASH values H*₁, H*₂, . . . , H*ₙ corresponding to the software update sub-packets P1, P2, . . . , Pn, constructing the Merkle tree, calculating the root HASH value H*ₗₙ of the Merkle tree, and checking H*ₗₙ?=Hₗₙ, wherein in a case that H*ₗₙ and Hₗₙ are not equal to each other, it indicates that at least one of the software update sub-packets P1, P2, . . . , Pn is tampered with and its integrity is destroyed in the process of being transmitted to the target ECU-UAs through the gateway or the domain controller, and thus the ECU-UAs destroy the received software update sub-packets P1, P2, . . . , Pn, and terminate update of each ECU; and
S12: updating, refreshing and installing, by the UC-master, respective ECUs to complete update operations, in a case that H*ₗₙ and Hₗₙ are equal to each other, which indicates that the second integrity verification is passed.

8. The method according to claim 2, wherein implementation steps of the stage of system key initialization comprise:
S1, activating an OTA system, and applying, by the OTA cloud service platform, for a public-private key pair (PK1, SK1) from the PKI service cloud platform;
S2, at the PKI service cloud platform, generating, the public-private key pair (PK1, SK1), and returning the public-private key pair (PK1, SK1) to the OTA cloud service platform, and at the OTA cloud service platform, saving the private key SK1, and sending the public key PK1 to the UC-master of the vehicle-side OTA system; and
S3: applying, by the vehicle-side UC-master, for a public-private key pair (PK2, SK2) from the PKI service cloud platform, generating, by the PKI service cloud platform, the public-private key pair (PK2, SK2) and sending the public-private key pair (PK2, SK2) to the vehicle-side UC-master, and at the vehicle-side UC-master, saving the private key SK2 and sending the public key PK2 to the OTA cloud service platform.

9. The method according to claim 3, wherein implementation steps of the stage of software update packet building comprise:
S4: uploading, by the software update packet supplier, the software update packet Packet=P(P1, P2, . . . , Pn) to the OTA cloud service platform;
S5: performing, by the OTA cloud service platform, the HASH operation on software update sub-packets P1, P2, . . . , Pn to obtain HASH values H1, H2, . . . , Hn, and constructing the Merkle tree according to these HASH values, calculating a root HASH value Hₗₙ of the Merkle tree, and transmitting the root HASH value Hₗₙ to an encryption algorithm module;
S6: performing by the OTA cloud service platform, the HASH operation on the software update packet Packet to obtain a message digest D=H(Packet), and encrypting a message digest D with a private key SK1 of the OTA cloud service platform, to form an encrypted digest D′=EN_{SK1}(D) wherein EN_{SK1}(#) indicates that the encryption operation is performed on # with the private key SK1, the encrypted digest D′ is attached behind the Packet to form a data packet Packet′=(Packet, D′), and the encryption operation is performed on the data packet Packet′ and Hₗₙ with the public key PK₂ of the vehicle-side UC-master to form an encrypted data packet Packet″=EN_{PK}_{₂}(Packet′, Hₗₙ) of the update software, and the encrypted update data packet Packet″ is distributed to the CDN; and
S7: returning, by the CDN, a download link URL forming message, and issuing, by an OTA administrator, an update command to the CDN through a Web console after receiving the download link URL forming message.

10. The method according to claim 4, wherein implementation step of the stage of vehicle-side software packet downloading, secondary verification and updating comprise:
S8: downloading, by the vehicle-side UC-master, the encrypted data packet Packet″ of the update software according to the download link URL;
S9: performing, by the vehicle-side UC-master, a decryption operation (Packet′, Hₗₙ)=DE_{SK}_{₂}(Packet″) on the downloaded encrypted data packet Packet″ of the update software with a private key SK2 of the vehicle-side UC-master, wherein DE_{SK}_{₂}(#) indicates that the decryption operation is performed on # with the private key SK2 to obtain an original software update packet Packet=P(P1, P2, . . . , Pn), an encrypted digest D′, and the root HASH value Hₗₙ of the Merkle tree;
S10: performing, by the vehicle-side UC-master, the signature verification on the decrypted software update packet Packet, which comprises: performing, by the vehicle-side UC-master, the decryption operation on the encrypted digest D′ by using the public key PK1 of the OTA cloud service platform to obtain a digest D=DE_{PK}_{₁}(D′) of the original software update packet, and performing the HASH operation on the decrypted original software update packet Packet to obtain a message digest D*=H(Packet) for verification, and checking D*?=D, wherein in a case that D* and D are equal to each other, the first integrity verification of the software update packet is passed; in a case that D* and D are not equal to each other, the vehicle-side UC-master destroys the received Packet″ and terminates the update process;
S11: performing an integrity verification on the software update sub-packets received by the ECU-UA to implement the second integrity verification, which comprises: performing by the UC-master, an unpacking operation on the decrypted original software update packet Packet to obtain the software update sub-packets P1, P2, . . . , Pn, and transmitting the software update sub-packets to ECU-UAs corresponding to respective ECUs through a communication gateway and a communication network between the ECUs such as a CAN bus, LAN interconnection network (LIN), vehicle Ethernet, WIFI or Bluetooth, and performing, by the UC-master, the HASH operation on the software update sub-packets P1, P2, . . . , Pn received by respective ECU-UAs to obtain HASH values H*₁, H*₂, . . . , H*ₙ corresponding to the software update sub-packets P1, P2, . . . , Pn, constructing the Merkle tree, calculating the root HASH value Hₗₙ of the Merkle tree, and checking H*ₗₙ?=Hₗₙ, wherein in a case that H*ₗₙ and Hₗₙ are not equal to each other, it indicates that at least one of the software update sub-packets P1, P2, . . . , Pn is tampered with and its integrity is destroyed in the process of being transmitted to the target ECU-UAs through the gateway or the domain controller, and thus the ECU-UAs destroy the received software update sub-packets P1, P2, . . . , Pn, and terminate update of each ECU; and
S12: updating, refreshing and installing, by the UC-master, respective ECUs to complete update operations, in a case that H*ₗₙ and Hₗₙ are equal to each other, which indicates that the second integrity verification is passed.

11. An Over-the-Air (OTA) security update system for an intelligent connected vehicle, which is used to implement the OTA security update method for the intelligent connected vehicle according to claim 1,
the OTA security update system comprises an OTA cloud service platform, a Public Key Infrastructure (PKI) service cloud platform and a vehicle-side OTA system, wherein the OTA cloud service platform comprises an OTA service platform, a CDN file service, an OME-IT system and a Web console, which are used to realize OEM cloud docking, vehicle model/vehicle/ECU version information management, software update management, update strategy creation, ECU associated update configuration, update mode configuration, release, etc.;
the PKI service cloud platform is used to generate encrypted and decrypted public-private key pairs, wherein a private key is used to generate a signature of an update packet, and a public key is used to verify the signature; and
the vehicle-side OTA system comprises an OTA update master, a signature verification module, a Merkle tree construction and root HASH value calculation module, a Merkle tree root HASH value comparison module, an updated ECU, a communication gateway between ECUs and a communication network between ECUs inside a vehicle.

12. The system according to claim 11, wherein in the stage of system key initialization, an OTA cloud service platform is configured with a key pair (PK2, SK1), and a vehicle-side OTA system is configured with a key pair (PK1, SK2), by interacting with a Public Key Infrastructure (PKI) service cloud platform; wherein PK1 and SK1 are a public key and a private key of the OTA cloud service platform, respectively, and PK2 and SK2 are a public key and a private key of the vehicle-side OTA system, respectively.

13. The system according to claim 11, wherein the stage of software update packet building is used to complete a preparation of the software update packet, and upload the software update packet to a CDN to form a download link URL, which comprises uploading, by a software update packet supplier, a software update packet Packet to an OTA cloud service platform, performing, by the OTA cloud service platform, a signature operation on the whole software update packet Packet by using a private key SK1 of the OTA cloud service platform, performing an encryption operation on the update packet Packet, an encrypted digest D′ and the root HASH value Hₗₙ of the Merkle tree constructed according to the HASH values of the software update sub-packets P1, P2, . . . , Pn by using a public key PK2 of the vehicle-side UC-master, and uploading the encrypted update packet Packet″=EN_{PK}_{₂}(Packet′, Hₗₙ) to the CDN to form the download link URL.

14. The system according to claim 11, wherein in the stage of vehicle-side software packet downloading, secondary verification and updating, the vehicle-side UC-master downloads an encrypted software update packet Packet″, decrypts the Packet″ with its own private key SK2, verifies a signature with a public key PK1 of an OTA cloud service platform, and transmits a decrypted root HASH value Hₗₙ of the Merkle tree to a comparison module through a secure channel; in a case that a signature verification is passed, respective software update sub-packets P1, P2, . . . , Pn are transmitted to a target ECU-UA through a gateway or a domain controller, and a Merkle tree is constructed according to the HASH values of the software update sub-packets received by respective ECU-UAs, a root HASH value H*ₗₙ of the Merkle tree is calculated and transmitted to the comparison module; in a case that H*ₗₙ=Hₗₙ, the second integrity verification of the software update sub-packet is passed, and each ECU is updated, refreshed and installed.

15. The system according to claim 11, wherein implementation steps of the stage of system key initialization comprise:
S1, activating an OTA system, and applying, by the OTA cloud service platform, for a public-private key pair (PK1, SK1) from the PKI service cloud platform;
S2, at the PKI service cloud platform, generating, the public-private key pair (PK1, SK1), and returning the public-private key pair (PK1, SK1) to the OTA cloud service platform, and at the OTA cloud service platform, saving the private key SK1, and sending the public key PK1 to the UC-master of the vehicle-side OTA system; and
S3: applying, by the vehicle-side UC-master, for a public-private key pair (PK2, SK2) from the PKI service cloud platform, generating, by the PKI service cloud platform, the public-private key pair (PK2, SK2) and sending the public-private key pair (PK2, SK2) to the vehicle-side UC-master, and at the vehicle-side UC-master, saving the private key SK2 and sending the public key PK2 to the OTA cloud service platform.

16. The system according to claim 11, wherein implementation steps of the stage of software update packet building comprise:
S4: uploading, by the software update packet supplier, the software update packet Packet=P(P1, P2, . . . , Pn) to the OTA cloud service platform;
S5: performing, by the OTA cloud service platform, the HASH operation on software update sub-packets P1, P2, . . . , Pn to obtain HASH values H1, H2, . . . , Hn, and constructing the Merkle tree according to these HASH values, calculating a root HASH value Hₗₙ of the Merkle tree, and transmitting the root HASH value Hₗₙ to an encryption algorithm module;
S6: performing by the OTA cloud service platform, the HASH operation on the software update packet Packet to obtain a message digest D=H(Packet), and encrypting a message digest D with a private key SK1 of the OTA cloud service platform, to form an encrypted digest D′=EN_{SK1}(D), wherein EN_{SK1}(#) indicates that the encryption operation is performed on # with the private key SK1, the encrypted digest D′ is attached behind the Packet to form a data packet Packet′=(Packet, D′), and the encryption operation is performed on the data packet Packet′and Hₗₙ with the public key PK₂ of the vehicle-side UC-master to form an encrypted data packet (Packet′, Hₗₙ) of the update software, and the encrypted update data packet P is distributed to the CDN; and
S7: returning, by the CDN, a download link URL forming message, and issuing, by an OTA administrator, an update command to the CDN through a Web console after receiving the download link URL forming message.

17. The system according to claim 11, wherein implementation step of the stage of vehicle-side software packet downloading, secondary verification and updating comprise:
S8: downloading, by the vehicle-side UC-master, the encrypted update data packet Packet″ of the update software according to the download link URL;
S9: performing, by the vehicle-side UC-master, decryption operation (Packet′, Hₗₙ)=DE_{SK}_{₂}(Packet″) on the downloaded encrypted data packet Packet″ of the update software with a private key SK2 of the vehicle-side UC-master, wherein DE_{SK}_{₂}(#) indicates that the decryption operation is performed on # with the private key SK2 to obtain an original software update packet Packet=P(P1, P2, . . . , Pn), an encrypted digest D′, and the root HASH value Hₗₙ of the Merkle tree;
S10: performing, by the vehicle-side UC-master, the signature verification on the decrypted software update packet Packet, which comprises: performing, by the vehicle-side UC-master, the decryption operation on the encrypted digest D′ by using the public key PK1 of the OTA cloud service platform to obtain a digest D=DE_{PK}_{₁}(D′) of the original software update packet, and performing the HASH operation on the decrypted original software update packet Packet to obtain a message digest D*=H(Packet), and checking D*?=D, wherein in a case that D* and D are equal to each other, the first integrity verification of the software update packet is passed; in a case that D* and D are not equal to each other, the vehicle-side UC-master destroys the received and terminates the update process;
S11: performing an integrity verification on the software update sub-packets received by the ECU-UA to implement the second integrity verification, which comprises: performing by the UC-master, an unpacking operation on the decrypted original software update packet Packet to obtain the software update sub-packets P1, P2, . . . , Pn, and transmitting the software update sub-packets to ECU-UAs corresponding to respective ECUs through a communication gateway and a communication network between the ECUs such as a CAN bus, LAN interconnection network (LIN), vehicle Ethernet, WIFI or Bluetooth, and performing, by the UC-master, the HASH operation on the software update sub-packets P1, P2, . . . , Pn received by respective ECU-UAs to obtain HASH values H*₁, H*₂, . . . , H*ₙ corresponding to the software update sub-packets P1, P2, . . . , Pn, constructing the Merkle tree, calculating the root HASH value Hₗₙ of the Merkle tree, and checking H*ₗₙ?=Hₗₙ, wherein in a case that Him and Hₗₙ are not equal to each other, it indicates that at least one of the software update sub-packets P1, P2, . . . , Pn is tampered with and its integrity is destroyed in the process of being transmitted to the target ECU-UA through the gateway or the domain controller, and thus the ECU-UAs destroy the received software update sub-packets P1, P2, . . . , Pn, and terminate update of each ECU; and
S12: updating, refreshing and installing, by the UC-master, respective ECUs to complete update operations, in a case that H*ₗₙ and Hₗₙ are equal to each other, which indicates that the second integrity verification is passed.

18. The system according to claim 12, wherein implementation steps of the stage of system key initialization comprise:
S1, activating an OTA system, and applying, by the OTA cloud service platform, for a public-private key pair (PK1, SK1) from the PKI service cloud platform;
S2, at the PKI service cloud platform, generating, the public-private key pair (PK1, SK1), and returning the public-private key pair (PK1, SK1) to the OTA cloud service platform, and saving the private key SK1 at the OTA cloud service platform, and sending the public key PK1 to the UC-master of the vehicle-side OTA system; and
S3: applying, by the vehicle-side UC-master, for a public-private key pair (PK2, SK2) from the PKI service cloud platform, generating, by the PKI service cloud platform, the public-private key pair (PK2, SK2) and sending the public-private key pair (PK2, SK2) to the vehicle-side UC-master, and saving the private key SK2 at the vehicle-side UC-master, and sending the public key PK2 to the OTA cloud service platform.

19. The system according to claim 13, wherein implementation steps of the stage of software update packet building comprise:
S4: uploading, by the software update packet supplier, the software update packet Packet=P(P1, P2, . . . , Pn) to the OTA cloud service platform;
S5: performing, by the OTA cloud service platform, the HASH operation on software update sub-packets P1, P2, . . . , Pn to obtain HASH values H1, H2, . . . , Hn, and constructing the Merkle tree according to these HASH values, calculating a root HASH value Hₗₙ of the Merkle tree, and transmitting the HASH value Hₗₙ to an encryption algorithm module;
S6: performing by the OTA cloud service platform, the HASH operation on the software update packet Packet to obtain a message digest D=H(Packet), and encrypting a message digest D with a private key SK1 of the OTA cloud service platform, to form an encrypted digest D′=EN_{SK1}(D), wherein EN_{SK1}(#) indicates that the encryption operation is performed on # with the private key SK1, the encrypted digest D′ is attached behind the Packet to form a data packet Packet′=(Packet, D′), and the encryption operation is performed on the data packet Packet′ and Hₗₙ with the public key PK₂ of the vehicle-side UC-master to form an encrypted data packet Packet″=EN_{PK}_{₂}(Packet′, Hₗₙ) of the update software, and the encrypted update data packet is distributed to the CDN; and
S7: returning, by the CDN, a download link URL forming message, and issuing, by an OTA administrator, an update command to the CDN through a Web console after receiving the download link URL forming message.

20. The system according to claim 14, wherein implementation step of the stage of vehicle-side software packet downloading, secondary verification and updating comprise:
S8: downloading, by the vehicle-side UC-master, the encrypted data packet Packet″ of the update software according to the download link URL;
S9: performing, by the vehicle-side UC-master, a decryption operation (Packet′, Hₗₙ)=DE_{SK}_{₂}(Packet″) on the downloaded encrypted data packet Packet″ of the update software with a private key SK2 of the vehicle-side UC-master, wherein DE_{SK}_{₂}(#) indicates that the decryption operation is performed on # with the private key SK2 to obtain an original software update packet Packet=P(P1, P2, . . . , Pn), an encrypted digest D′, and the root HASH value Hₗₙ of the Merkle tree;
S10: performing, by the vehicle-side UC-master, the signature verification on the decrypted software update packet Packet, which comprises: performing, by the vehicle-side UC-master, the decryption operation on the encrypted digest D′ by using the public key PK1 of the OTA cloud service platform to obtain a digest D=DE_{PK}_{₁}(D′) of the original software update packet, and performing the HASH operation on the decrypted original software update packet Packet to obtain a message digest D*=H(Packet), and checking D*?=D, wherein in a case that D* and D are equal to each other, the first integrity verification of the software update packet is passed; in a case that D* and D are not equal to each other, the vehicle-side UC-master destroys the received Packet and terminates the update process;
S11: performing an integrity verification on the software update sub-packets received by the ECU-UAs to implement the second integrity verification, which comprises: performing by the UC-master, an unpacking operation on the decrypted original software update packet Packet to obtain the software update sub-packets P1, P2, . . . , Pn, and transmitting the software update sub-packets to ECU-UAs corresponding to respective ECUs through a communication gateway and a communication network between the ECUs such as a CAN bus, LAN interconnection network (LIN), vehicle Ethernet, WIFI or Bluetooth, and performing, by the UC-master, the HASH operation on the software update sub-packets P1, P2, . . . , Pn received by respective ECU-UAs to obtain HASH values H*₁, H*₂, . . . , H*ₙ corresponding to the software update sub-packets P1, P2, . . . , Pn, constructing the Merkle tree, calculating the root HASH value H*ₗₙ of the Merkle tree, and checking H*ₗₙ?=Hₗₙ, wherein in a case that H*ₗₙ and Hₗₙ are not equal to each other, it indicates that at least one of the software update sub-packets P1, P2, . . . , Pn is tampered with and its integrity is destroyed in the process of being transmitted to the target ECU-UA through the gateway or the domain controller, and thus the ECU-UAs destroy the received software update sub-packets P1, P2, . . . , Pn, and terminate update of each ECU; and
S12: updating, refreshing and installing, by the UC-master, respective ECUs to complete update operations, in a case that H*ₗₙ and Hₗₙ are equal to each other, which indicates that the second integrity verification is passed.
